(19) United States
(12) Patent Application Publication
(10) Pub. No.: US 2024/0141203 A1
(43) Pub. Date: May 2, 2024

(54) THREE-DIMENSIONAL PRINTING WITH SOLUBILIZING AGENTS

(71) Applicant: Hewlett-Packard Development Company, L.P., Spring, TX (US)

(72) Inventors: Emre Hiro DISCEKICI, San Diego, CA (US); Shannon Reuben WOODRUFF, San Diego, CA (US); Mark KOWALSKI, Corvallis, OR (US); Alay YEMANE, San Diego, CA (US); Graciela Emma NEGRI JIMENEZ, San Diego, CA (US)

(21) Appl. No.: 18/269,742

(22) PCT Filed: Jan. 5, 2021
(86) PCT No.: PCT/US2021/012129

§ 371 Date: Jun. 26, 2023

(51) Int. Cl. C09D 177/04; B33Y 70/10; C09D 7/20

(52) U.S. Cl. CPC C09D 177/04; B33Y 70/10; C09D 7/20; B29K 2077/00

(57) ABSTRACT

The present disclosure describes multi-fluid kits for three-dimensional printing, three-dimensional printing kits, and systems for three-dimensional printing. In one example, a multi-fluid kit for three-dimensional printing can include a fusing agent, a solubilizing agent, and a detailing agent. The fusing agent can include water and an electromagnetic radiation absorber. The electromagnetic radiation absorber can absorb radiation energy and convert the radiation energy to heat. The solubilizing agent can include benzyl alcohol, an organic cosolvent, and water. The detailing agent can include a detailing compound.

### BACKGROUND

Methods of three-dimensional (three-dimensional) digital printing, a type of additive manufacturing, have continued to be developed over the last few decades. However, systems for three-dimensional printing have historically been very expensive, though those expenses have been coming down to more affordable levels recently. Three-dimensional printing technology can shorten the product development cycle by allowing rapid creation of prototype models for reviewing and testing. Unfortunately, the concept has been somewhat limited with respect to commercial production capabilities because the range of materials used in three-dimensional printing is likewise limited. Accordingly, it can be difficult to print three-dimensional functional parts with desired properties such as mechanical strength, visual appearance, and so on. Nevertheless, several commercial sectors such as aviation and the medical industry have benefitted from the ability to rapidly prototype and customize parts for customers.

### BRIEF DESCRIPTION OF THE DRAWINGS

FIG. 1 is a schematic view of an example multi-fluid kit for three-dimensional printing in accordance with examples of the present disclosure.

FIG. 2 is a schematic view of an example three-dimensional printing kit in accordance with examples of the present disclosure.

FIG. 3 is a schematic view of another example three-dimensional printing kit in accordance with examples of the present disclosure.

FIGS. 4A-4C show a schematic view of an example three-dimensional printing process using an example three-dimensional printing kit in accordance with examples of the present disclosure.

FIG. 5 is a schematic view of an example system for three-dimensional printing in accordance with examples of the present disclosure.

### DETAILED DESCRIPTION

The present disclosure describes multi-fluid kits for three-dimensional printing, three-dimensional printing kits, and systems for three-dimensional printing. In one example, a multi-fluid kit for three-dimensional printing includes a fusing agent, a solubilizing agent, and a detailing agent. The fusing agent includes water and an electromagnetic radiation absorber, wherein the electromagnetic radiation absorber absorbs radiation energy and converts the radiation energy to heat. The solubilizing agent includes benzyl alcohol, an organic cosolvent, and water. The detailing agent includes a detailing compound. In some examples, the organic cosolvent can include polyethylene glycol. In other examples, the organic cosolvent can be present in the solubilizing agent in an amount from about 20 wt % to about 70 wt %. In further examples, the benzyl alcohol can be present in the solubilizing agent in an amount from about 10 wt % to about 40 wt %. In still further examples, the water can be present in the solubilizing agent in an amount from about 20 wt % to about 70 wt %.

The present disclosure also describes three-dimensional printing kits. In one example, a three-dimensional printing kit includes a powder bed material and a solubilizing agent. The powder bed material includes polyamide polymer particles. The solubilizing agent includes from 10 wt % to 40 wt % benzyl alcohol, an organic cosolvent, and water. In some examples, the solubilizing agent can also include an electromagnetic radiation absorber, wherein the electromagnetic radiation absorber absorbs radiation energy and converts the radiation energy to heat. In other examples, the three-dimensional printing kit can also include a fusing agent that includes water and an electromagnetic radiation absorber, wherein the electromagnetic radiation absorber absorbs radiation energy and converts the radiation energy to heat. In certain examples, the polyamide polymer particles can include polyamide 6, polyamide 9, polyamide 11, polyamide 12, polyamide 66, polyamide 612, thermoplastic polyamide, polyamide copolymer, or a combination thereof. In further examples, the organic cosolvent can be polyethylene glycol having a molecular weight of about 200 Mw or greater. In certain other examples, the organic cosolvent can be present in the solubilizing agent in an amount from about 20 wt % to about 70 wt %, and the benzyl alcohol can be present in the solubilizing agent in an amount from about 10 wt % to about 40 wt %, and the water can be present in the solubilizing agent in an amount from about 20 wt % to about 70 wt %. In some examples, the three-dimensional printing kit can also include a detailing agent that includes a detailing compound to reduce a temperature of the powder bed material onto which the detailing agent is applied. In other examples, the three-dimensional printing kit can be used to prepare a three-dimensional printed object. The three-dimensional printed object can include multiple fused layers of the powder bed material having the benzyl alcohol and an electromagnetic radiation absorber embedded in the fused layers of powder bed material. The electromagnetic radiation absorber can absorb radiation energy and convert the radiation energy to heat.

The present disclosure also describes systems for three-dimensional printing. In one example, a system for three-dimensional printing includes a powder bed material, a fusing agent to selectively apply to a layer of the powder bed material, a solubilizing agent to selectively apply to the layer of the powder bed material, and a radiant energy source positioned to expose the layer of powder bed material to radiation energy. The powder bed material includes polyamide polymer particles. The fusing agent includes water and an electromagnetic radiation absorber, wherein the electromagnetic radiation absorber absorbs radiation energy and converts the radiation energy to heat. The solubilizing agent includes from about 10 wt % to about 40 wt % benzyl alcohol, an organic cosolvent, and water. The radiation energy selectively fuses the polyamide polymer particles in contact with the electromagnetic radiation absorber and thereby forms a three-dimensional printed object. In certain examples, the polyamide polymer particles can include polyamide 6, polyamide 9, polyamide 11, polyamide 12, polyamide 66, polyamide 612, thermoplastic polyamide, polyamide copolymer, or a combination thereof. In further examples, the organic cosolvent can include polyethylene glycol.

It is noted that when discussing the multi-fluid kits, three-dimensional printing kits, and systems herein, these discussions can be considered applicable to one another whether or not they are explicitly discussed in the context of that example. Thus, for example, when discussing a fusing agent related to a three-dimensional printing kit, such disclosure is also relevant to and directly supported in the context of multi-fluid kits and systems, vice versa, etc.

It is also understood that terms used herein will take on their ordinary meaning in the relevant technical field unless specified otherwise. In some instances, there are terms defined more specifically throughout the specification or included at the end of the present specification, and thus, these terms have a meaning as described herein.

### Multi-Fluid Kits for Three-Dimensional Printing

The multi-fluid kits, three-dimensional printing kits, and methods described herein can be used to make three-dimensional printed objects while allowing certain properties of the three-dimensional printed objects to be adjusted by applying a solubilizing agent during the three-dimensional printing process. In particular, the solubilizing agent can increase the elasticity and ductility of the three-dimensional printed object. Therefore, objects that are printed using these materials can be less stiff and brittle compared to objects printed without the solubilizing agent. The solubilizing agent described herein can include benzyl alcohol. Without being bound to a particular mechanism, in some examples the benzyl alcohol can solubilize polyamide polymer powder that is used as a build material. In particular, the polyamide polymer can dissolve in the presence of the benzyl alcohol, especially when the temperature is elevated. In some examples, the three-dimensional printing processes described herein can include fusing polyamide polymer particles together at an elevated temperature. The dissolution of the polyamide polymer in the presence of the benzyl alcohol can help the polymer particles fuse more completely, which can result in better mechanical properties of the final three-dimensional printed object.

Plasticizers have sometimes been used with polymers such as polyamides to increase the elasticity and ductility of the polymers. Many plasticizers change the properties of the polymer through mechanisms involving hydrogen bonding between the plasticizer compound and the polymer. This is different from the solubilization mechanism between benzyl alcohol and polyamide polymer that is utilized in the present disclosure. In many cases, plasticizers are used in relatively large amounts to impart a desired level of elasticity to a polymer. In comparison, benzyl alcohol can be added to polyamide polymer in relatively lower amounts while still achieving a desired level of elasticity.

As used herein, “elasticity” refers to the ability of a material to deform in response to mechanical stress and then return to the original shape of the material when the stress is removed. In specific examples, the elasticity can be quantified in terms of the Young's modulus. The Young's modulus refers to the ratio of stress (in terms of force per area, such as in units of pascals) to the proportional strain (a unitless measure of the deformation of the material compared to the original shape of the material). A higher Young's modulus is understood to represent a less elastic material. In some examples, the Young's modulus of a material can be measured by a testing system such as an INSTRON® tensile tester, available from Instron (USA).

Additionally, the term “ductility” refers to the ability of a material be drawn out by a tensile force without breaking. Ductile materials may be drawn to a longer length and a narrow cross-section by a tensile force with fracturing. In some cases, the material can be drawn out beyond the elastic region of the material, which is the region in which the material can be deformed and then returned elastically to its original shape when the tensile force is removed. In some examples, ductility can be measured by applying a tensile force to a material and measuring the strain (i.e., the length of the material proportional to the original length) at the point when the material fractures. Materials with a higher ductility can have a higher strain at the breaking point. In some examples, the strain at break can also be measured by a testing system such as the INSTRON® tensile tester, available from Instron (USA).

In some examples described herein, three-dimensional printed objects can be made using certain three-dimensional printing processes that involve fusing layers of polyamide polymer powder to form solid layers of a three-dimensional printed object. In one process, a fusing agent can be applied onto a powder bed of polyamide polymer particles. The fusing agent can include an electromagnetic radiation absorber, which can be a material that absorbs radiant energy and converts the energy to heat. Radiant energy can be applied to the powder bed to heat and fuse the polymer particles on which the fusing agent was applied. Thus, the polymer particles can be heated to a temperature that is high enough to fuse the polymer particles together, which can be from 70° C. to 350° C. or higher, depending on the specific type of build material. In this process, benzyl alcohol can be applied to the build material. For example, benzyl alcohol can be included in the fusing agent or in a separate solubilizing agent that is applied together with the fusing agent.

In certain examples of the three-dimensional printing processes describe herein, the fusing agent can be applied using jetting architecture such as an inkjet print head. Such a system can jet small droplets of the fusing agent at selected locations on the powder bed with a high resolution. This can allow for making high resolution, detailed three-dimensional printed objects.

In certain examples, using a solubilizing agent together with a fusing agent can allow for fine control over the adjustment of elasticity and ductility of the polyamide polymer. For example, the amount of benzyl alcohol applied to the polymer can be easily adjusted by changing the amount of the solubilizing agent that is applied during the three-dimensional printing process. Additionally, these properties can be controlled spatially in three dimensions, meaning that different portions of the volume of the three-dimensional printed object can be given different mechanical properties by selectively applying the solubilizing agent in different amounts in different areas of the build material, or by omitting the solubilizing agent in some areas and applying the solubilizing agent in other areas.

In the particular three-dimensional printing processes described herein, it has often been found that applying a second fluid agent in addition to the fusing agent can actually result in more brittle three-dimensional printed objects. This may be a result of the second fluid agent interfering with the fusing together of polymer particles. For example, the second fluid agent may cool the polymer particles to a lower temperature, which can reduce the amount of fusing between polymer particles. In some cases, this can result in a final three-dimensional printed part with reduced strength and increased brittleness.

However, it has surprisingly been found that the solubility agents described herein have the opposite effect. Even when the solubilizing agent is a second fluid agent that is used in addition to a fusing agent, the solubilizing agent can have the effect of increasing elasticity and ductility of the final three-dimensional printed object, when compared to printing the same object using fusing agent alone.

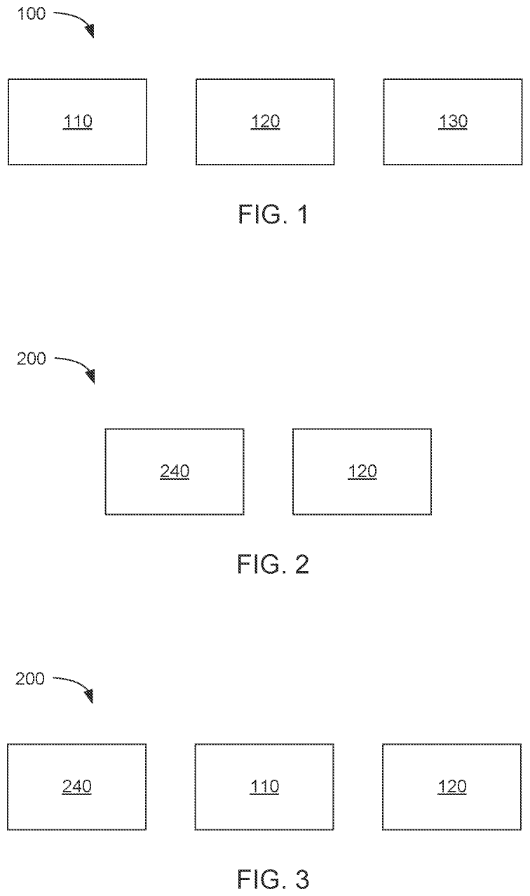

With this description in mind, FIG. 1 shows a schematic illustration of an example multi-fluid kit for three-dimensional printing 100. The kit includes a fusing agent 110, a solubilizing agent 120, and a detailing agent 130. The fusing agent can include water and an electromagnetic radiation absorber. The electromagnetic radiation absorber can absorb radiation energy and convert the radiation energy to heat. The solubilizing agent can include benzyl alcohol, an organic cosolvent, and water. The detailing agent can include a detailing compound.

The multi-fluid kits can be used in the three-dimensional printing processes described herein. In various examples, the fusing agent can be applied to a powder bed material in areas where the powder bed material is to be fused together. The powder bed can then be exposed to radiant energy. The energy absorber in the fusing agent can absorb the radiant energy and convert the energy to heat, which can cause the areas where the fusing agent was applied to heat up to a higher temperature than other areas of the powder bed. In this way, the powder bed material with the fusing agent applied can heat up to a sufficient temperature to fuse the polymer particles of the powder bed together, while the surrounding polymer particles can remain unfused.

In some examples, a detailing agent can be used together with the fusing agent. The detailing agent can include a detailing compound, which is a compound that can reduce the temperature of powder bed material onto which the detailing agent is applied. In some examples, the detailing agent can be applied around edges of the area where the fusing agent is applied. This can prevent powder bed material around the edges from caking due to heat from the area where the fusing agent was applied. The detailing agent can also be applied in the same area where fusing was applied in order to control the temperature and prevent excessively high temperatures when the powder bed material is fused.

Additionally, as described above, the solubilizing agent can be used to impart a higher level of ductility and elasticity to the polymer. The solubilizing agent can be selectively applied to any area of the powder bed material where higher ductility and elasticity is desired. In some examples, the solubilizing agent can be applied in all the same areas where the fusing agent is applied. This can result in a final three-dimensional printed object that has enhanced elasticity throughout the entire object.

The compositions of the fusing agent, solubilizing agent, and detailing agent, and their use in three-dimensional printing, are described in more detail below.

### Three-Dimensional Printing Kits

The present disclosure also describes three-dimensional printing kits. In some examples, the three-dimensional printing kits can include materials that can be used in the three-dimensional printing processes described herein. FIG. 2 shows a schematic illustration of one example three-dimensional printing kit 200 in accordance with examples of the present disclosure. The kit includes a powder bed material 240 including polymer particles and a solubilizing agent 120 to selectively apply to the powder bed material. The solubilizing agent can include benzyl alcohol, an organic cosolvent, and water. In a certain example, the benzyl alcohol can be present in an amount from 10 wt % to 40 wt %.

In some examples, the solubilizing agent can act as both a solubilizing agent and a fusing agent simultaneously. In these examples, the solubilizing agent can include an electromagnetic radiation absorber that can absorb radiation energy and convert the energy to heat. Such a solubilizing agent can be applied to the powder bed material to areas that are to be fused, and the powder bed can be irradiated as explained above. The benzyl alcohol in the solubilizing agent can impart a greater elasticity and ductility to the fused polymer, so that the entire three-dimensional printed object has enhanced elasticity and ductility.

In alternative examples, the three-dimensional kit can include a solubilizing agent and a fusing agent that are two separate fluid agents. In these examples, the solubilizing agent may not include an electromagnetic radiation absorber. Therefore, the solubilizing agent can be selectively applied together with the fusing agent in some areas to enhance the elasticity of the fused polymer, while in other areas the fusing agent can be applied to form fused polymer that does not have enhanced elasticity, FIG. 3 shows one such example three-dimensional printing kit 200. This example includes a powder bed material 240, a fusing agent 110, and a solubilizing agent 120. If a detailing agent is to be used in the three-dimensional printing process, then a detailing agent can also be included in the three-dimensional printing kit.

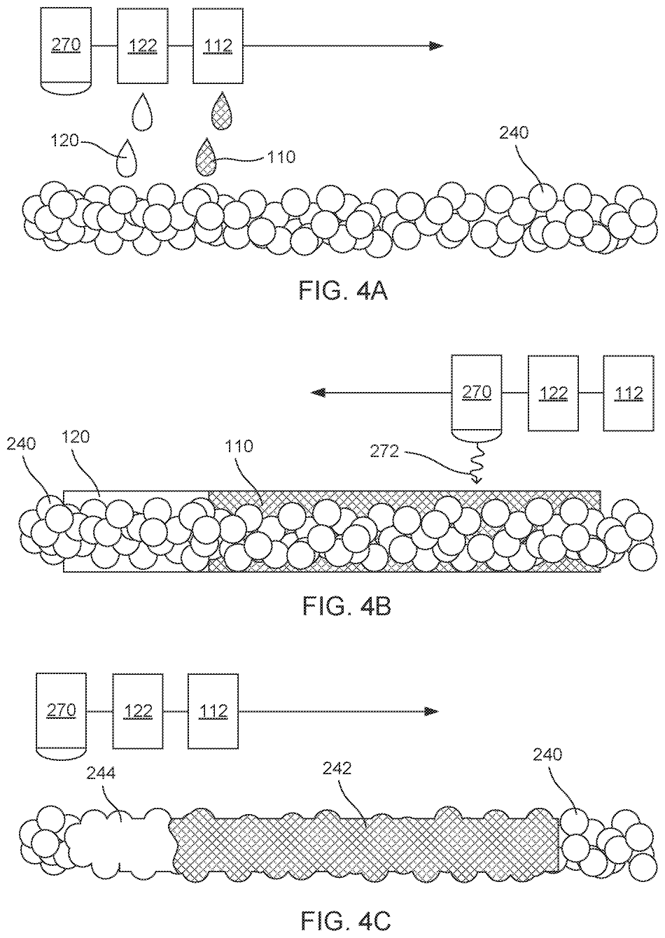

To illustrate the use of the three-dimensional printing kits and multi-fluid kits described herein, FIGS. 4A-4C illustrate one example of using a three-dimensional printing kit to form a three-dimensional printed object. In FIG. 4A, a fusing agent 110 and a solubilizing agent 120 are jetted onto a layer of powder bed material 240. The fusing agent is jetted from a fusing agent ejector 112 and the solubilizing agent is jetted from a solubilizing agent ejector 122. These fluid ejectors can move across the layer of powder bed material to selectively jet fusing agent on areas that are to be fused. The solubilizing agent can be jetted in areas where enhanced elasticity and ductility is desired. A radiation source 270 can also move across the layer of powder bed material.

FIG. 4B shows the layer of powder bed material 240 after the fusing agent 110 and solubilizing agent 120 have been jetted onto an area of the layer that is to be fused. As shown in this figure, the fusing agent is also jetted onto the same area where the solubilizing agent has been jetted, so that this area has a combination of the fusing agent and the solubilizing agent thereon. The portion where the solubilizing agent was jetted will become a part of the final three-dimensional printed object that has enhanced elasticity. The radiation source 270 is shown emitting radiation 272 toward the layer of polymer particles. The fusing agent can include a radiation absorber that can absorb this radiation and convert the radiation energy to heat.

FIG. 4C shows the layer of powder bed material 240 with a fused portion 242 where the fusing agent was jetted. This portion has reached a sufficient temperature to fuse the polymer particles together to form a solid polymer matrix. The area where the solubilizing agent was jetted becomes a portion having enhanced elasticity 244. This portion can be more elastic and ductile compared to the remainder of the fused portion where the solubilizing agent was not jetted. In particular, the portion having enhanced elasticity may have different properties such as a lower Young's modulus or a greater strain at break.

The process shown in FIGS. 4A-4C can be repeated multiple times with additional layers of powder bed material. Individual layers of powder bed material can be deposited over the top of previous layers, and the fusing agent and solubilizing agent can be applied as shown in FIG. 4A, The individual layers can also be irradiated with electromagnetic energy as shown in FIG. 4B. This can fused together the polymer particles of the powder bed material to form fused layers as shown in FIG. 4C. By repeating this process with multiple layers, a three-dimensional printed object can be formed.

In some examples, the final three-dimensional printed object can be made up of multiple fused layers of powder bed material. The electromagnetic radiation absorber from the fusing agent can remain embedded in the fused layers. In the portions of the object where the solubilizing agent was applied, the benzyl alcohol can also remain embedded in the fused layers. In certain examples, a portion of the benzyl alcohol may evaporate from the powder bed due to the elevated temperatures used during the three-dimensional printing process. However, a portion of the benzyl alcohol can still remain and be present in the final three-dimensional printed object. The benzyl alcohol can be present in the specific portions of the three-dimensional printed object that have enhanced elasticity. Other portions of the object, without enhanced elasticity, may be devoid of the benzyl alcohol. In certain examples, the portions of the object that have enhanced elasticity can include the benzyl alcohol in an amount from about 0.1 wt % to about 5 wt %, with respect to the total weight of those portions of the three-dimensional printed object. In further examples, the entire three-dimensional printed object may have enhanced elasticity, and the benzyl alcohol can be present in the entire three-dimensional printed object in an amount from about 0.1 wt % to about 5 wt %.

### Systems for Three-Dimensional Printing

The present disclosure also describes systems for three-dimensional printing that can be used to perform the three-dimensional printing processes described herein. In a particular example, a system for three-dimensional printing can include a powder bed material that includes polyamide polymer particles, a fusing agent to selectively apply to a layer of the powder bed material, a solubilizing agent to selectively apply to the layer of the powder bed material, and a radiant energy source positioned to expose the layer of powder bed material to radiation energy. The fusing agent can include water and an electromagnetic radiation absorber. The electromagnetic radiation absorber can absorb radiation energy and convert the radiation energy to heat. The solubilizing agent can include from about 10 wt % to about 40 wt % of benzyl alcohol. The solubilizing agent can also include water and an organic cosolvent. The radiation energy from the radiant energy source can selectively fuse the polyamide polymer particles that are in contact with the electromagnetic radiation absorber. By fusing together multiple layers of powder bed material in this way, a three-dimensional printed object can be formed.

In further examples, the systems for three-dimensional printing can include additional components. For example, the system can include applicators for applying fluid agents such as the fusing agent and solubilizing agent. In one example, the system can include a fusing agent applicator that can be fluidly coupled or coupleable to a fusing agent. The fusing agent applicator can be directable to iteratively apply the fusing agent to layers of the particulate build material. In further examples, the system can also include a solubilizing agent applicator. The solubilizing applicator can be coupled or coupleable to a solubilizing agent, and directable to apply the solubilizing agent onto layers of the particulate build material.

As used herein, “fluidly coupled” and “coupleable” can refer to the capability of the fluid agent applicators to access the fluid agents (i.e., fusing agent, solubilizing agent, detailing agent, etc.) and apply the fluid agents onto the particulate build material. In some examples, the printing system can include a fusing agent reservoir that is fluidly coupled to the fusing agent applicator, meaning that the fusing agent can flow from the reservoir to the fusing agent applicator and the fusing agent applicator can apply the fusing agent to the particulate build material. In other examples, the fusing agent applicator can be coupleable to an external reservoir of fusing agent, meaning that the fusing agent applicator can be configured to connect to the fusing agent reservoir, but the fusing agent reservoir may not be present in the printing system per se.

In further examples, the system can further include a radiant energy source positioned to expose the layers of particulate build material to radiation energy to selectively fuse the particulate build material in contact with the electromagnetic radiation absorber and thereby form a three-dimensional printed object. In another example, the system can include a hardware controller in communication with the fluid agent applicators and the radiant energy source. The hardware controller can be programmed to direct the fluid agent applicators to apply the various fluid agents onto the particulate build material. In a particular example, the hardware controller can be programmed to direct the fusing agent applicator to iteratively and selectively apply the fusing agent to build material layers based on a three-dimensional object model. The hardware controller can also be programmed to direct a radiant energy source of the three-dimensional printing system to expose the layer of powder bed material to radiation energy to selectively fuse the particulate build material in contact with the electromagnetic radiation absorber and thereby form a three-dimensional printed object. In still further examples, the hardware controller can also be programmed to generate a command to direct a build material applicator of the three-dimensional printing system to apply particulate build material layers to a powder bed of the three-dimensional printing system.

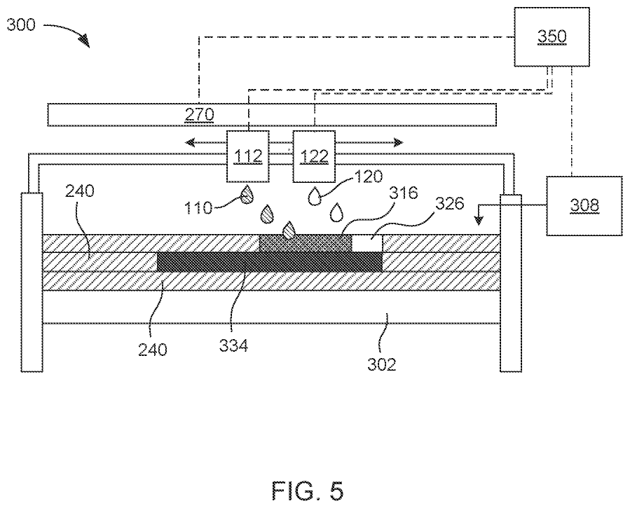

FIG. 5 shows an example three-dimensional printing system 300 in accordance with the present disclosure. The system includes a build platform 302. Particulate build material 240 can be deposited onto the build platform by a build material applicator 308 where the particulate build material can be flattened or smoothed, such as by a mechanical roller or other flattening technique. This can form a flat layer of particulate build material. The fusing agent 110 can then be applied to the layer by a fusing agent applicator 112. A solubilizing agent 120 can also be applied by a solubilizing agent applicator 122. A first area 316 where the fusing agent is applied can correspond to a layer or slice of a three-dimensional object model. The solubilizing agent can be applied to a second area 326, which can be a portion of the area where the fusing agent is applied. In other examples, the solubilizing agent can have its own radiation absorbing properties and can act as a fusing agent on its own, and therefore may be applied to an area where the fusing agent was not applied. The system also includes a radiant energy source 270 that can expose the powder bed to radiant energy to fuse the particulate build material where the fusing agent was applied. FIG. 5 shows a first layer of fused polymer 334 that has already formed, with an additional layer of particulate build material spread over the top, and the system is in the process of applying the fusing agent and solubilizing agent to the additional layer to form another layer of the three-dimensional printed object. In further detail, there can be a hardware controller 350 connected to the fusing agent applicator, solubilizing agent applicator, radiant energy source, and build material applicator. The hardware controller can be programmed to direct the components of the system to perform their functions. For example, the hardware controller can generate a command to direct a build material applicator of the three-dimensional printing system to apply particulate build material layers to a powder bed of the three-dimensional printing system, direct the fusing agent applicator to iteratively and selectively apply the fusing agent to build material layers based on a three-dimensional object model, and direct a radiant energy source of the three-dimensional printing system to expose the layer of powder bed material to radiation energy to selectively fuse the particulate build material in contact with the electromagnetic radiation absorber and thereby form a three-dimensional printed object, or a combination thereof.

In some examples, the hardware controller can include a module or modules for performing the operations described above. For example, the hardware controller can include a module for directing the solubilizing agent applicator to apply the solubilizing agent onto the particulate build material in a sufficient amount to form an area having enhanced elasticity. Other modules can include modules for directing the fusing agent applicator, radiant energy source, build platform, build material applicator, heaters, and so on. These functional units of the three-dimensional printing system are described as modules in order to emphasize their implementation independence. For example, a module can be implemented as a hardware circuit including custom very-large-scale integration (VLSI) circuits or gate arrays, off-the-shelf semiconductors such as logic chips, transistors, or other discrete components. A module can also be implemented in programmable hardware devices such as field programmable gate arrays, programmable array logic, programmable logic devices or the like.

Modules can also be implemented in machine-readable software for execution by various types of processors. An identified module of executable code can, for instance, include block(s) of computer instructions, which can be organized as an object, procedure, or function. Nevertheless, the executables of an identified module need not be physically located together, but can include disparate instructions stored in different locations which include the module and achieve the stated purpose for the module when joined logically together.

Indeed, a module of executable code can be a single instruction, or many instructions, and can even be distributed over several different code segments, among different programs, and across several memory devices. Similarly, operational data can be identified and illustrated herein within modules, and can be in a suitable form and organized within a suitable type of data structure. The operational data can be collected as a single data set, or can be distributed over different locations including over different storage devices. The modules can be passive or active, including agents operable to perform desired functions.

The modules described here can also be stored on a computer readable storage medium that includes volatile and non-volatile, removable and non-removable media implemented with a disclosure for the storage of information such as computer readable instructions, data structures, program modules, or other data. Computer readable storage media can include, but are not limited to, RAM, ROM, electrically erasable programmable read-only memory (EEPROM), flash memory or other memory disclosure, compact disc read-only memory (CD-ROM), digital versatile disks (DVD) or other optical storage, magnetic cassettes, magnetic tapes, magnetic disk storage or other magnetic storage devices, or other computer storage medium which can be used to store the desired information.

In some examples the hardware controller can include some or all of the modules described above as hardware components. In other examples, the hardware controller can be capable of executing the modules described above as software modules. In some examples, a combination of hardware and software modules can be used.

In further detail, the systems for three-dimensional printing can be capable of adjusting a variety of variables to affect the three-dimensional printing process. These variables can be referred to as the “print mode” of the three-dimensional printing process. Such variables can include, for example, amounts of the fluid agents that are applied to the powder bed, the thickness of layers of powder bed material, the temperature of the powder bed, the intensity and length of time at which radiant energy is applied to the powder bed, and so on.

In some examples, the amount of the fusing agent used can be calibrated based on the concentration of radiation absorber in the fusing agent, the level of fusing desired for the polymer particles, and other factors. In some examples, the amount of fusing agent printed can be sufficient to contact the radiation absorber with the entire layer of polymer powder. For example, if individual layers of polymer powder are 100 microns thick, then the fusing agent can penetrate 100 microns into the polymer powder. Thus the fusing agent can heat the polymer powder throughout the entire layer so that the layer can coalesce and bond to the layer below. After forming a solid layer, a new layer of loose powder can be formed, either by lowering the powder bed or by raising the height of a powder roller and rolling a new layer of powder.

In some examples, the entire powder bed can be preheated to a temperature below the melting or softening point of the polymer powder. In one example, the preheat temperature can be from about 10° C. to about 30° C. below the melting or softening point. In another example, the preheat temperature can be within 50° C. of the melting or softening point. In a particular example, the preheat temperature can be from about 160° C. to about 170° C. and the polymer powder can be polyamide 12 powder. Preheating can be accomplished with a lamp or lamps, an oven, a heated support bed, or other types of heaters. In some examples, the entire powder bed can be heated to a substantially uniform temperature.

The powder bed can be irradiated with a fusing lamp. Suitable fusing lamps for use in the methods described herein can include commercially available infrared lamps and halogen lamps. The fusing lamp can be a stationary lamp or a moving lamp. For example, the lamp can be mounted on a track to move horizontally across the powder bed. Such a fusing lamp can make multiple passes over the bed depending on the amount of exposure to coalesce printed layers. The fusing lamp can be configured to irradiate the entire powder bed with a substantially uniform amount of energy. This can selectively coalesce the printed portions with fusing agent leaving the unprinted portions of the polymer powder below the melting or softening point.

In one example, the fusing lamp can be matched with the radiation absorber in the fusing agent so that the fusing lamp emits wavelengths of light that match the peak absorption wavelengths of the radiation absorber. A radiation absorber with a narrow peak at a particular near-infrared wavelength can be used with a fusing lamp that emits a narrow range of wavelengths at approximately the peak wavelength of the radiation absorber. Similarly, a radiation absorber that absorbs a broad range of near-infrared wavelengths can be used with a fusing lamp that emits a broad range of wavelengths. Matching the radiation absorber and the fusing lamp in this way can increase the efficiency of coalescing the polymer particles with the fusing agent printed thereon, while the unprinted polymer particles do not absorb as much light and remain at a lower temperature.

Depending on the amount of radiation absorber present in the polymer powder, the absorbance of the radiation absorber, the preheat temperature, and the melting or softening point of the polymer, an appropriate amount of irradiation can be supplied from the fusing lamp. In some examples, the fusing lamp can irradiate individual layers from about 0.5 to about 10 seconds per pass.

The three-dimensional printed object can be formed by jetting a fusing agent onto layers of powder bed build material according to a three-dimensional object model. Three-dimensional object models can in some examples be created using computer aided design (CAD) software. Three-dimensional object models can be stored in any suitable file format. In some examples, a three-dimensional printed object as described herein can be based on a single three-dimensional object model. The three-dimensional object model can define the three-dimensional shape of the object. In some examples, the three-dimensional object model can also include a particular three-dimensional portion of the object that is desired to have an enhanced elasticity provided by applying the solubilizing agent. Other information may also be included, such as structures to be formed of additional different materials or color data for printing the object with various colors at different locations on the object. The three-dimensional object model may also include features or materials specifically related to jetting fluids on layers of powder bed material, such as the desired amount of fluid to be applied to a given area. This information may be in the form of a droplet saturation, for example, which can instruct a three-dimensional printing system to jet a certain number of droplets of fluid into a specific area. This can allow the three-dimensional printing system to finely control radiation absorption, cooling, color saturation, concentration of the benzyl alcohol from the solubilizing agent in the powder bed material, and so on. All this information can be contained in a single three-dimensional object file or a combination of multiple files. The three-dimensional printed object can be made based on the three-dimensional object model. As used herein, “based on the three-dimensional object model” can refer to printing using a single three-dimensional object model file or a combination of multiple three-dimensional object models that together define the object. In certain examples, software can be used to convert a three-dimensional object model to instructions for a three-dimensional printer to form the object by building up individual layers of build material.

In an example of the three-dimensional printing process, a thin layer of polymer powder can be spread on a bed to form a powder bed. At the beginning of the process, the powder bed can be empty because no polymer particles have been spread at that point. For the first layer, the polymer particles can be spread onto an empty build platform. The build platform can be a flat surface made of a material sufficient to withstand the heating conditions of the three-dimensional printing process, such as a metal. Thus, “applying individual build material layers of polymer particles to a powder bed” includes spreading polymer particles onto the empty build platform for the first layer. In other examples, a number of initial layers of polymer powder can be spread before the printing begins. These “blank” layers of powder bed material can in some examples number from about 10 to about 500, from about 10 to about 200, or from about 10 to about 100. In some cases, spreading multiple layers of powder before beginning the print can increase temperature uniformity of the three-dimensional printed object. A fluid jet printing head, such as an inkjet print head, can then be used to print a fusing agent including a radiation absorber over portions of the powder bed corresponding to a thin layer of the three-dimensional object to be formed. Then the bed can be exposed to electromagnetic energy, e.g., typically the entire bed. The electromagnetic energy can include light, infrared radiation, and so on. The radiation absorber can absorb more energy from the electromagnetic energy than the unprinted powder. The absorbed light energy can be converted to thermal energy, causing the printed portions of the powder to soften and fuse together into a formed layer. After the first layer is formed, a new thin layer of polymer powder can be spread over the powder bed and the process can be repeated to form additional layers until a complete three-dimensional object is printed. Thus, “applying individual build material layers of polymer particles to a powder bed” also includes spreading layers of polymer particles over the loose particles and fused layers beneath the new layer of polymer particles

### Powder Bed Materials

As mentioned above, the three-dimensional printing processes described can utilize a powder bed build material that includes polyamide polymer particles. Polyamide polymers can include a variety of polymers that include polymerized monomers linked together by amide linkages. The benzyl alcohol that is included in the solubilizing agent can have a solubilizing effect on polyamide polymers. This has been found to result in three-dimensional printed objects with enhanced elasticity when the benzyl alcohol is applied to the polyamide polymer particles during three-dimensional printing.

Polyamide polymers that an be used in the three-dimensional printing kits, systems, and processes described herein can include polyamide 6, polyamide 9, polyamide 11, polyamide 12, polyamide 66, polyamide 612, thermoplastic polyamide, polyamide copolymer, or a combination thereof. In some examples, the polyamide polymer particles can be made up entirely of a single type of polyamide polymer. In other examples, a mixture of two or more types of polyamide polymers can be used.

In certain examples, the powder bed material can include polymer particles having a variety of shapes, such as substantially spherical particles or irregularly-shaped particles. In some examples, the polymer powder can be capable of being formed into three-dimensional printed objects with a resolution of about 20 μm to about 100 μm, about 30 μm to about 90 μm, or about 40 μm to about 80 μm. As used herein, “resolution” refers to the size of the smallest feature that can be formed on a three-dimensional printed object. The polymer powder can form layers from about 20 μm to about 100 μm thick, allowing the fused layers of the printed part to have roughly the same thickness. This can provide a resolution in the z-axis (i.e., depth) direction of about 20 μm to about 100 μm. The polymer powder can also have a sufficiently small particle size and sufficiently regular particle shape to provide about 20 μm to about 100 μm resolution along the x-axis and y-axis (i.e., the axes parallel to the top surface of the powder bed). For example, the polymer powder can have an average particle size from about 20 μm to about 100 μm. In other examples, the average particle size can be from about 20 μm to about 50 μm. Other resolutions along these axes can be from about 30 μm to about 90 μm or from about 40 μm to about 80 μm.

The polymer powder can have a melting or softening point from about 70° C. to about 350° C. In further examples, the polymer can have a melting or softening point from about 150° C. to about 200° C. In a specific example, the polymer powder can be polyamide 12, which can have a melting point from about 175° C. to about 200° C.

The polymer particles can also in some cases be blended with a filler. The filler can include inorganic particles such as alumina, silica, fibers, carbon nanotubes, or combinations thereof. When the thermoplastic polymer particles fuse together, the filler particles can become embedded in the polymer, forming a composite material. In some examples, the filler can include a free-flow agent, anti-caking agent, or the like. Such agents can prevent packing of the powder particles, coat the powder particles and smooth edges to reduce inter-particle friction, and/or absorb moisture. In some examples, a weight ratio of thermoplastic polymer particles to filler particles can be from about 100:1 to about 1:2 or from about 5:1 to about 1:1.

### Fusing Agents

The multi-fluid kits and three-dimensional printing kits described herein can include a fusing agent to be applied to the polymer build material. The fusing agent can include a radiation absorber that can absorb radiant energy and convert the energy to heat. In certain examples, the fusing agent can be selectively applied to areas of the powder bed material that are desired to be consolidated to become part of the solid three-dimensional printed object. The fusing agent can be applied, for example, by printing such as with a fluid ejector or fluid jet print head. Fluid jet print heads can jet the fusing agent in a similar way to an inkjet print head jetting ink. Accordingly, the fusing agent can be applied with great precision to certain areas of the powder bed material that are desired to form a layer of the final three-dimensional printed object. After applying the fusing agent, the powder bed material can be irradiated with radiant energy. The radiation absorber from the fusing agent can absorb this energy and convert it to heat, thereby heating any polymer particles in contact with the radiation absorber. An appropriate amount of radiant energy can be applied so that the area of the powder bed material that was printed with the fusing agent heats up enough to melt the polymer particles to consolidate the particles into a solid layer, while the powder bed material that was not printed with the fusing agent remains as a loose powder with separate particles.

In some examples, the amount of radiant energy applied, the amount of fusing agent applied to the powder bed, the concentration of radiation absorber in the fusing agent, and the preheating temperature of the powder bed (i.e., the temperature of the powder bed material prior to printing the fusing agent and irradiating) can be tuned to ensure that the portions of the powder bed printed with the fusing agent will be fused to form a solid layer and the unprinted portions of the powder bed will remain a loose powder. These variables can be referred to as parts of the “print mode” of the three-dimensional printing system. The print mode can include any variables or parameters that can be controlled during three-dimensional printing to affect the outcome of the three-dimensional printing process.

The process of forming a single layer by applying fusing agent and irradiating the powder bed can be repeated with additional layers of fresh powder bed material to form additional layers of the three-dimensional printed object, thereby building up the final object one layer at a time. In this process, the powder bed material surrounding the three-dimensional printed object can act as a support material for the object. When the three-dimensional printing is complete, the object can be removed from the powder bed and any loose powder on the object can be removed.

Accordingly, in some examples, the fusing agent can include a radiation absorber that is capable of absorbing electromagnetic radiation to produce heat. The radiation absorber can be colored or colorless. In various examples, the radiation absorber can be a pigment such as carbon black pigment, glass fiber, titanium dioxide, clay, mica, talc, barium sulfate, calcium carbonate, a near-infrared absorbing dye, a near-infrared absorbing pigment, a conjugated polymer, a dispersant, or combinations thereof. Examples of near-infrared absorbing dyes include aminium dyes, tetraaryldiamine dyes, cyanine dyes, pthalocyanine dyes, dithiolene dyes, and others. In further examples, radiation absorber can be a near-infrared absorbing conjugated polymer such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof. As used herein, “conjugated” refers to alternating double and single bonds between atoms in a molecule, Thus, “conjugated polymer” refers to a polymer that has a backbone with alternating double and single bonds. In many cases, the radiation absorber can have a peak absorption wavelength in the range of about 800 nm to about 1400 nm.

A variety of near-infrared pigments can also be used. Non-limiting examples can include phosphates having a variety of counterions such as copper, zinc, iron, magnesium, calcium, strontium, the like, and combinations thereof. Non-limiting specific examples of phosphates can include M₂P₂O₇, M₄P₂O₉, MP₂O₁₀, Md(PO₄)₂, M(PO)₂, M₂P₄O₁₂, and combinations thereof, where M represents a counterion having an oxidation state of +2, such as those listed above or a combination thereof. For example, M₂P₂O₇ can include compounds such as Cu₂P₂O₇, Cu/MgP₂O₇, Cu/ZnP₂O₇, or any other suitable combination of counterions. It is noted that the phosphates described herein are not limited to counterions having a +2 oxidation state. Other phosphate counterions can also be used to prepare other suitable near-infrared pigments.

Additional near-infrared pigments can include silicates. Silicates can have the same or similar counterions as phosphates. One non-limiting example can include M₂SiO₄, M₂Si₂O₆, and other silicates where M is a counterion having an oxidation state of +2. For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. It is noted that the silicates described herein are not limited to counterions having a +2 oxidation state. Other silicate counterions can also be used to prepare other suitable near-infrared pigments.

In further examples, the radiation absorber can include a metal dithiolene complex. Transition metal dithiolene complexes can exhibit a strong absorption band in the 600 nm to 1600 nm region of the electromagnetic spectrum. In some examples, the central metal atom can be any metal that can form square planer complexes. Non-limiting specific examples include complexes based on nickel, palladium, and platinum.

In further examples, the radiation absorber can include a tungsten bronze or a molybdenum bronze. In certain examples, tungsten bronzes can include compounds having the formula MₓWO₃, where M is a metal other than tungsten and x is equal to or less than 1. Similarly, in some examples, molybdenum bronzes can include compounds having the formula MₓMoO₃, where M is a metal other than molybdenum and x is equal to or less than 1.

In still other examples, the radiation absorber can be selected to provide that the fusing agent is a “low tint fusing agent” that may be transparent, pale in color, or white. For example, the electromagnetic radiation absorber may be transparent or white at wavelengths ranging from about 400 nm to about 780 nm. In some examples, the term “transparent” as used herein, indicates that about 20% or less of the radiation having wavelengths from about 400 nm to about 780 nm is absorbed. Thus, in examples herein, the low tint fusing agent can be white, colorless, or pale in coloration so that coloring agents can be effective in coloring the polymeric powder bed material without much, if any, interference in coloration from the radiation absorber. At the same time, the low tint fusing agent can generate heat when exposed to electromagnetic energy wavelengths from 800 nm to 4,000 nm sufficient to partially or fully melt or coalesce the polymeric powder bed material that is in contact with the low tint fusing agent. In alternative examples, the radiation absorber can preferentially absorb ultraviolet radiation. In some examples, the radiation absorber can absorb radiation in wavelength range from about 300 nm to about 400 nm. In certain examples, the amount of electromagnetic energy absorbed by the fusing agent can be quantified as follows: a layer of the fusing agent having a thickness of 0.5 μm after liquid components have been removed can absorb from 90% to 100% of radiant electromagnetic energy having a wavelength within a wavelength range from about 300 nm to about 400 nm. The radiation absorber may also absorb little or no visible light, thus making the radiation absorber transparent to visible light. In certain examples, the 0.5 μm layer of the fusing agent can absorb from 0% to 20% of radiant electromagnetic energy in a wavelength range from above about 400 nm to about 700 nm. Non-limiting examples of ultraviolet absorbing radiation absorbers can include nanoparticles of titanium dioxide, zinc oxide, cerium oxide, indium tin oxide, or a combination thereof. In some examples, the nanoparticles can have an average particle size from about 2 nm to about 300 nm, from about 10 nm to about 100 nm, or from about 10 nm to about 60 nm.

A dispersant can be included in the fusing agent in some examples. Dispersants can help disperse the radiation absorbing pigments described above. In some examples, the dispersant itself can also absorb radiation, Non-limiting examples of dispersants that can be included as a radiation absorber, either alone or together with a pigment, can include polyoxyethylene glycol octylphenol ethers, ethoxylated aliphatic alcohols, carboxylic esters, polyethylene glycol ester, anhydrosorbitol ester, carboxylic amide, polyoxyethylene fatty acid amide, poly (ethylene glycol) p-isooctyl-phenyl ether, sodium polyacrylate, and combinations thereof.

The amount of radiation absorber in the fusing agent can vary depending on the type of radiation absorber. In some examples, the concentration of radiation absorber in the fusing agent can be from about 0.1 wt % to about 20 wt %. In one example, the concentration of radiation absorber in the fusing agent can be from about 0.1 wt % to about 15 wt %. In another example, the concentration can be from about 0.1 wt % to about 8 wt %. In yet another example, the concentration can be from about 0.5 wt % to about 2 wt %. In a particular example, the concentration can be from about 0.5 wt % to about 1.2 wt %. In one example, the radiation absorber can have a concentration in the fusing agent such that after the fusing agent is jetted onto the polymer powder, the amount of radiation absorber in the polymer powder can be from about 0.0003 wt % to about 10 wt %, or from about 0.005 wt % to about 5 wt %, with respect to the weight of the polymer powder.

In some examples, the fusing agent can be jetted onto the polymer powder build material using a fluid jetting device, such as inkjet printing architecture. Accordingly, in some examples, the fusing agent can be formulated to give the fusing agent good jetting performance. Ingredients that can be included in the fusing agent to provide good jetting performance can include a liquid vehicle. Thermal jetting can function by heating the fusing agent to form a vapor bubble that displaces fluid around the bubble, and thereby forces a droplet of fluid out of a jet nozzle. Thus, in some examples the liquid vehicle can include a sufficient amount of an evaporating liquid that can form vapor bubbles when heated. The evaporating liquid can be a solvent such as water, an alcohol, an ether, or a combination thereof.

In some examples, the liquid vehicle formulation can include a co-solvent or co-solvents present in total at from about 1 wt % to about 50 wt %, depending on the jetting architecture. Further, a non-ionic, cationic, and/or anionic surfactant can be present, ranging from about 0.01 wt % to about 5 wt %. In one example, the surfactant can be present in an amount from about 1 wt % to about 5 wt %. The liquid vehicle can include dispersants in an amount from about 0.5 wt % to about 3 wt %. The balance of the formulation can be purified water, and/or other vehicle components such as biocides, viscosity modifiers, materials for pH adjustment, sequestering agents, preservatives, and the like. In one example, the liquid vehicle can be predominantly water.

In some examples, a water-dispersible or water-soluble radiation absorber can be used with an aqueous vehicle. Because the radiation absorber is dispersible or soluble in water, an organic co-solvent may not be present, as it may not be included to solubilize the radiation absorber. Therefore, in some examples the fluids can be substantially free of organic solvent, e.g., predominantly water. However, in other examples a co-solvent can be used to help disperse other dyes or pigments, or enhance the jetting properties of the respective fluids. In still further examples, a non-aqueous vehicle can be used with an organic-soluble or organic-dispersible fusing agent.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol and 1,5-pentanediol.

Regarding the surfactant that may be present, a surfactant or surfactants can be used, such as alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. The amount of surfactant added to the fusing agent may range from about 0.01 wt % to about 20 wt %. Suitable surfactants can include, but are not limited to, liponic esters such as TERGITOL™ 15-S-12, TERGITOL™ 15-S-7, TERGITOL™ 15-S-9 available from Dow Chemical Company (Michigan), LEG-1 and LEG-7; TRITON™ X-100; TRITON™ X-405 available from Dow Chemical Company (Michigan); and sodium dodecylsulfate.

Various other additives can be employed to enhance certain properties of the fusing agent for specific applications. Examples of these additives are those added to inhibit the growth of harmful microorganisms. These additives may be biocides, fungicides, and other microbial agents, which can be used in various formulations. Examples of suitable microbial agents include, but are not limited to, NUOSEPT® (Nudex, Inc., New Jersey), UCARCIDE™ (Union carbide Corp., Texas), VANCIDE® (R.T. Vanderbilt Co., Connecticut), PROXEL® (ICI Americas, New Jersey), ACTICIDE® (Thor, United Kingdom), and combinations thereof.

Sequestering agents, such as EDTA (ethylene diamine tetra acetic acid), may be included to eliminate the deleterious effects of heavy metal impurities, and buffer solutions may be used to control the pH of the fluid. From about 0.01 wt % to about 2 wt %, for example, can be used. Viscosity modifiers and buffers may also be present, as well as other additives to modify properties of the fluid as desired. Such additives can be present at from about 0.01 wt % to about 20 wt %.

In certain further examples, the fusing agent can include from about 5 wt % to about 40 wt % organic co-solvent, from about 0 wt % to about 20 wt % high boiling point solvent, from about 0.1 wt % to about 1 wt % surfactant, from about 0.1 wt % to about 1 wt % anti-kogation agent, from about 0.01 wt % to about 1 wt % chelating agent, from about 0.01 wt % to about 1 wt % biocide, and from about 1 wt % to about 10 wt % carbon black pigment. The balance can be deionized water.

### Solubilizing Agents

The solubilizing agent can be a fluid agent that includes benzyl alcohol, an organic cosolvent, and water. As explained above, the benzyl alcohol can solubilize polyamide polymers. The solubilizing agent can be applied to individual layers of polyamide polymer particles during the three-dimensional printing process. After the solubilizing agent has been applied to a layer of loose particles, the particles are fused together using radiant energy. A new layer of loose polyamide polymer particles can then be spread over the fused layer, and the process can be repeated for additional layers. When the solubilizing agent is applied to individual layers in this way, the final three-dimensional printed object can be significantly more elastic and ductile than if the same object were formed using fusing agent without the solubilizing agent.

Additionally, without being bound to a specific mechanism, in some examples benzyl alcohol can have a stronger solubilizing effect on polyamide polymers at an elevated temperature. The temperatures utilized to fuse the polyamide polymer particles during three-dimensional printing can be sufficient to increase the solubilizing effect of the benzyl alcohol. Therefore, the three-dimensional printing processes described herein can provide appropriate conditions for the benzyl alcohol to solubilize the polyamide polymer.

The concentration of benzyl alcohol in the solubilizing agent can be selected based on the desired elasticity enhancement for the three-dimensional printed objects and the amount of the solubilizing agent that will be applied during three-dimensional printing. In some examples, the amount of benzyl alcohol in the solubilizing agent can be from about 10 wt % to about 40 wt %. Concentrations in this range can be sufficient to allow the solubilizing agent to provide a significant elasticity enhancing effect to the three-dimensional printed object. In other examples, the concentration of benzyl alcohol can be from about 10 wt % to about 30 wt %, or from about 10 wt % to about 20 wt %, or from about 11 wt % to about 19 wt %, or from about 12 wt % to about 18 wt %, or from about 13 wt % to about 17 wt %, or from about 14 wt % to about 16 wt %, or from about 10 wt % to about 15 wt %, or from about 15 wt % to about 40 wt %, or from about 15 wt % to about 25 wt %, or from about 15 wt % to about 20 wt %. In further examples, the concentration of benzyl alcohol can be about 15 wt % or less, or about 17 wt % or less, or about 20 wt % or less, or about 25 wt % or less. In other examples, the concentration of benzyl alcohol can be about 15 wt % or more, or about 13 wt % or more, or about 10 wt % or more.

It should be noted that applying a second fluid agent, in addition to the fusing agent, during three-dimensional printing can sometimes tend to interfere with the fusing of the polymer particles. This can result in decreased mechanical strength in the final three-dimensional printed object. Accordingly, the concentration of benzyl alcohol in the solubilizing agent can be selected so that a sufficient amount of benzyl alcohol can be applied to the polymer particles without adding too much extra fluid. In some examples, the amount of benzyl alcohol that is applied to the polyamide polymer particles can be from about 0.1 wt % to about 5 wt % with respect to the combined weight of the polyamide polymer particles and benzyl alcohol together. In further examples, the amount of benzyl alcohol applied to the polymer particles can be from about 0.1 wt % to about 4 wt %, from about 0.1 wt % to about 2 wt %, from about 0.1 wt % to about 1 wt %, from about 0.5 wt % to about 1 wt %, from about 1 wt % to about 2 wt %, or from about 1 wt % to about 5 wt %, with respect to the combined weight of the polyamide polymer particles and benzyl alcohol together.

The solubilizing agent can also include an organic cosolvent. In some examples, the same types of organic cosolvents that can be used in fusing agents can also be used in the solubilizing agent. Examples of cosolvents that can be used can include aliphatic alcohols, aromatic alcohols, diols, glycol ethers, polyglycol ethers, caprolactams, formamides, acetamides, and long chain alcohols. Examples of such compounds include 1-aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include, but are not limited to, 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol and 1,5-pentanediol. In some examples, the organic cosolvent can include polyethylene glycol. In some specific examples, the polyethylene glycol can have a molecular weight that is about 200 Mw (weight average molecular weight) or greater. For example, the polyethylene glycol can have a weight average molecular weight from about 200 Mw to about 1,000 Mw, or from about 200 Mw to about 600 Mw, or from about 200 Mw to about 400 Mw.

The concentration of organic cosolvent in the solubilizing agent can be from about 20 wt % to about 70 wt % in some examples. In some cases, the benzyl alcohol in the solubilizing agent can be more soluble in the organic cosolvent than in pure water. Therefore, depending on the amount of benzyl alcohol in the solubilizing agent, the amount of organic cosolvent present can be sufficient to make the benzyl alcohol completely soluble in the solubilizing agent. In further examples, the concentration of organic cosolvent in the solubilizing agent can be from about 30 wt % to about 60 wt %, or from about 40 wt % to about 60 wt %, or from about 45 wt % to about 55 wt %, or from about 20 wt % to about 50 wt %, or from about 30 wt % to about 50 wt %, or from about 40 wt % to about 50 wt %, or from about 50 wt % to about 70 wt %, or from about 50 wt % to about 60 wt %.

In certain examples, the solubilizing agent can also include a surfactant. Examples of surfactants that can be used can include TERGITOL™ 15-S-12, TERGITOL™ 15-S-7, TERGITOL™ 15-S-9 available from Dow Chemical Company (Michigan); LEG-1 and LEG-7; TRITON™ X-100; TRITON™ X-405 available from Dow Chemical Company (Michigan); and sodium dodecylsulfate. In some examples, the concentration of surfactant in the solubilizing agent can be from about 0.1 wt % to about 2 wt %, or from about 0.1 wt % to about 1 wt % or from about 0.5 wt % to about 0.8 wt %, or from about 0.8 wt % to about 2 wt %, or from about 0.8 wt % to about 1.5 wt %.

The solubilizing agent can also include water. In various examples, the amount of water in the solubilizing agent can be from about 20 wt % to about 70 wt %. In further examples, the amount of water can be from about 25 wt % to about 50 wt %, or from about 30 wt % to about 40 wt %, or from about 20 wt % to about 35 wt %, or from about 20 wt % to about 50 wt %, or from about 35 wt % to about 50 wt %, or from about 35 wt % to about 70 wt %.

The solubilizing agent can also include additional ingredients to allow the agent to be jetted by a fluid jet print head. In some examples, the solubilizing agent can include jettability imparting ingredients such as those in the fusing agent described above. These ingredients can include dispersant, biocides, viscosity modifiers, materials for pH adjustment, sequestering agents, preservatives, and so on. These ingredients can be included in any of the amounts described above with respect to the fusing agents.

In a particular example, the solubilizing agent can consist of water, an organic cosolvent, a surfactant, and benzyl alcohol. In certain examples, the benzyl alcohol can be present in an amount from about 10 wt % to about 40 wt %, the organic cosolvent can be present in an amount from about 20 wt % to about 70 wt %, and the water can be present in an amount from about 20 wt % to about 70 wt %.

### Detailing Agents

In further examples, multi-fluid kits or three-dimensional printing kits can include a detailing agent. The detailing agent can include a detailing compound. The detailing compound can be capable of reducing the temperature of the powder bed material onto which the detailing agent is applied. In some examples, the detailing agent can be printed around the edges of the portion of the powder that is printed with the fusing agent. The detailing agent can increase selectivity between the fused and unfused portions of the powder bed by reducing the temperature of the powder around the edges of the portion to be fused.

In some examples, the detailing compound can be a solvent that evaporates at the temperature of the powder bed. In some cases the powder bed can be preheated to a preheat temperature within about 10° C. to about 70° C. of the fusing temperature of the polymer powder. Depending on the type of polymer powder used, the preheat temperature can be in the range of about 90° C. to about 200° C. or more. The detailing compound can be a solvent that evaporates when it comes into contact with the powder bed at the preheat temperature, thereby cooling the printed portion of the powder bed through evaporative cooling. In certain examples, the detailing agent can include water, co-solvents, or combinations thereof. Non-limiting examples of co-solvents for use in the detailing agent can include xylene, methyl isobutyl ketone, 3-methoxy-3-methyl-1-butyl acetate, ethyl acetate, butyl acetate, propylene glycol monomethyl ether, ethylene glycol mono tert-butyl ether, dipropylene glycol methyl ether, diethylene glycol butyl ether, ethylene glycol monobutyl ether, 3-Methoxy-3-Methyl-1-butanol, isobutyl alcohol, 1,4-butanediol, N,N-dimethyl acetamide, and combinations thereof. In some examples, the detailing agent can be mostly water. In a particular example, the detailing agent can be about 85 wt % water or more. In further examples, the detailing agent can be about 95 wt % water or more. In still further examples, the detailing agent can be substantially devoid of radiation absorbers. That is, in some examples, the detailing agent can be substantially devoid of ingredients that absorb enough radiation energy to cause the powder to fuse. In certain examples, the detailing agent can include colorants such as dyes or pigments, but in small enough amounts that the colorants do not cause the powder printed with the detailing agent to fuse when exposed to the radiation energy.

The detailing agent can also include ingredients to allow the detailing agent to be jetted by a fluid jet print head. In some examples, the detailing agent can include jettability imparting ingredients such as those in the fusing agent described above. These ingredients can include a liquid vehicle, surfactant, dispersant, co-solvent, biocides, viscosity modifiers, materials for pH adjustment, sequestering agents, preservatives, and so on. These ingredients can be included in any of the amounts described above.

In certain examples, the detailing agent can include from about 1 wt % to about 10 wt % organic co-solvent, from about 1 wt % to about 20 wt % high boiling point solvent, from about 0.1 wt % to about 2 wt % surfactant, from about 0.1 wt % to about 5 wt % anti-kogation agent, from about 0.01 wt % to about 5 wt % chelating agent, from about 0.01 wt % to about 4 wt % biocide, and the balance can be deionized water.

### Definitions

It is noted that, as used in this specification and the appended claims, the singular forms “a,” “an,” and “the” include plural referents unless the context clearly dictates otherwise.

As used herein, “colorant” can include dyes and/or pigments.

As used herein, “dye” refers to compounds or molecules that absorb electromagnetic radiation or certain wavelengths thereof. Dyes can impart a visible color to an ink if the dyes absorb wavelengths in the visible spectrum.

As used herein, “pigment” includes pigment colorants, magnetic particles, aluminas, silicas, and/or other ceramics, organo-metallics or other opaque particles, whether or not such particulates impart color. Thus, though the present description describes the use of pigment colorants, the term “pigment” can be used to describe pigment colorants, and also other pigments such as organometallics, ferrites, ceramics, etc. In one specific aspect, however, the pigment is a pigment colorant.

As used herein, “applying” when referring to fusing agent and/or detailing agent, for example, refers to any technology that can be used to put or place the respective fluid agent on or into a layer of powder bed material for forming three-dimensional objects. For example, “applying” may refer to “jetting,” “ejecting,” “dropping,” “spraying,” or the like.

As used herein, “jetting” or “ejecting” refers to applying fluid agents or other compositions by expelling from ejection or jetting architecture, such as ink-jet architecture. Ink-jet architecture can include thermal or piezo architecture. Additionally, such architecture can be configured to print varying drop sizes such as from about 3 picoliters to less than about 10 picoliters, or to less than about 20 picoliters, or to less than about 30 picoliters, or to less than about 50 picoliters, etc.

As used herein, “average particle size” refers to a number average of the diameter of the particles for spherical particles, or a number average of the volume equivalent sphere diameter for non-spherical particles. The volume equivalent sphere diameter is the diameter of a sphere having the same volume as the particle. Average particle size can be measured using a particle analyzer such as the MASTERSIZER™ 3000 available from Malvern Panalytical (United Kingdom). The particle analyzer can measure particle size using laser diffraction. A laser beam can pass through a sample of particles and the angular variation in intensity of light scattered by the particles can be measured. Larger particles scatter light at smaller angles, while small particles scatter light at larger angles. The particle analyzer can then analyze the angular scattering data to calculate the size of the particles using the Mie theory of light scattering. The particle size can be reported as a volume equivalent sphere diameter.

As used herein, the term “substantial” or “substantially” when used in reference to a quantity or amount of a material, or a specific characteristic thereof, refers to an amount that is sufficient to provide an effect that the material or characteristic was intended to provide. The exact degree of deviation allowable may in some cases depend on the specific context. When using the term “substantial” or “substantially” in the negative, e.g., substantially devoid of a material, what is meant is from none of that material is present, or at most, trace amounts could be present at a concentration that would not impact the function or properties of the composition as a whole.

As used herein, the term “about” is used to provide flexibility to a numerical range endpoint by providing that a given value may be “a little above” or “a little below” the endpoint. The degree of flexibility of this term can be dictated by the particular variable and determined based on the associated description herein.

As used herein, a plurality of items, structural elements, compositional elements, and/or materials may be presented in a common list for convenience. However, these lists should be construed as though individual members of the list are individually identified as separate and unique members. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include the numerical values explicitly recited as the limits of the range, and also to include individual numerical values or sub-ranges encompassed within that range as if numerical values and sub-ranges are explicitly recited. As an illustration, a numerical range of “about 1 wt % to about 5 wt %” should be interpreted to include the explicitly recited values of about 1 wt % to about 5 wt %, and also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

### EXAMPLES

The following illustrates examples of the present disclosure. However, it is to be understood that the following are merely illustrative of the application of the principles of the present disclosure. Numerous modifications and alternative devices, methods, and systems may be devised without departing from the spirit and scope of the present disclosure. The appended claims are intended to cover such modifications and arrangements.

### Example 1—Solubility Agents

Two example solubilizing agents (SA A and SA B) were prepared with the compositions shown in Table 1. TERGITOL™ 15-S-9 is a surfactant available from Dow Chemical Company (Michigan).

TABLE 1

| | SA A | SA B |
|---|---|---|
| Ingredient | (wt %) | (wt %) |
| Polyethylene Glycol 200 Mw (cosolvent) | 50 | — |
| 2-hydroxyethyl-2-pyrrolidone (cosolvent) | — | 50 |
| Benzyl alcohol | 15 | 15 |
| TERGITOL ™ 15-S-9 (surfactant) | 0.8 | 0.8 |
| Deionized water | 34.2 | 34.2 |

To test the jettability of the example solubilizing agents, the agents were loaded in a 2D inkjet printer and used to print a test pattern on paper. A small amount of magenta dye was added to the solubilizing agents to allow the agents to be observed visually. The solubilizing agents both had good printability in the inkjet printer.

### Example 2—Mechanical Properties

The second example solubilizing agent, SA B, was loaded in a test three-dimensional printer. A fusing agent and a detailing agent were also loaded in the three-dimensional printer. The powder bed material used was polyamide-12 powder. A series of sample dogbone-shaped objects were printed using the three-dimensional printer. Three sets of dogbones were produced, with four dogbones in each set. The first set was printed using the fusing agent, without any solubilizing agent or detailing agent. The second set was printed by jetting the fusing agent and the solubilizing agent together throughout the entire volume of the printed dogbones. The third set was printed by jetting the fusing agent and the detailing agent together throughout the entire volume of the printed dogbones.

The sample printed dogbones were tested for tensile strength, Young's modulus, and strain at break. These properties were tested using an INSTRON® tensile tester (Instron, USA). The results of these tests are shown in Table 2.

TABLE 2

| Fluid Agents | Tensile | Young's | % Strain at |
|---|---|---|---|
| Applied | Strength (MPa) | Modulus (MPa) | Break |
| FA | 42.565 | 1488 | 284.48 |
| FA | 45.102 | 1513 | 177.19 |
| FA | 43.95 | 1417 | 239.88 |
| FA | 46.02 | 1645 | 248.94 |
| FA + SA B | 41.933 | 1157 | 312.23 |
| FA + SA B | 42.579 | 1192 | 314.14 |
| FA + SA B | 40.032 | 1003 | 318.41 |
| FA + SA B | 40.772 | 1113 | 304.22 |
| FA + DA | 41.978 | 1266 | 45.03 |
| FA + DA | 43.344 | 1372 | 40.3 |
| FA + DA | 40.937 | 1218 | 28.91 |
| FA + DA | 41.536 | 1217 | 56.06 |

These test results show that the solubilizing agent SA B significantly reduced the Young's modulus compared to the samples where fusing agent was used alone. The strain at break was also significantly increased by the solubilizing agent. Conversely, the samples printed with fusing agent and detailing agent had a much smaller strain at break, showing that adding the detailing agent made the polymer less ductile. Therefore, it appears that adding additional fluid during three-dimensional printing tends to reduce the ductility of the polymer. Thus, it is especially surprising that the solubilizing agent had the opposite effect, and increased the ductility of the polymer significantly. Neither the solubilizing nor the detailing agent had a large impact on the tensile strength of the polymer.

### Example 3—Injection Molding Tests

A series of dogbones were made from the same polyamide-12 powder using injection molding instead of three-dimensional printing, to see if the benzyl alcohol would have the same effects in injection molded parts. For these tests, three dogbones were formed of plain polyamide-12 powder by injection molding. Then, three dogbones were formed from polyamide-12 powder having 1 wt % of benzyl alcohol blended therein. The injection molded dogbones were tested for tensile strength, Young's modulus, and strain at break. The results are shown in Table 3.

TABLE 3

| | Tensile Strength | Young's Modulus | % Strain at |
|---|---|---|---|
| Material | (MPa) | (MPa) | Break |
| PA-12 | 45.03 | 1291 | 460.20 |
| PA-12 | 52.48 | 1458 | 577.87 |
| PA-12 | 52.65 | 1292 | 585.20 |
| PA-12 + benzyl | 57.16 | 1222 | 718.11 |
| alcohol | | | |
| PA-12 + benzyl | 52.19 | 1188 | 619.95 |
| alcohol | | | |
| PA-12 + benzyl | 52.48 | 1242 | 611.88 |
| alcohol | | | |

These results showed that the benzyl alcohol, again, had the effect of decreasing the Young's modulus and increasing the strain at break. However, the benzyl alcohol appears to make a larger difference in these properties when used in three-dimensional printing than in injection molding. Therefore, the solubilizing agent including benzyl alcohol appears to be especially useful for the three-dimensional printing processes described herein.

What is claimed is:

1. A multi-fluid kit for three-dimensional printing comprising:
a fusing agent comprising water and an electromagnetic radiation absorber, wherein the electromagnetic radiation absorber absorbs radiation energy and converts the radiation energy to heat;
a solubilizing agent comprising benzyl alcohol, an organic cosolvent, and water; and
a detailing agent comprising a detailing compound.

2. The multi-fluid kit of claim 1, wherein the organic cosolvent includes polyethylene glycol.

3. The multi-fluid kit of claim 1, wherein the organic cosolvent is present in the solubilizing agent in an amount from about 20 wt % to about 70 wt %.

4. The multi-fluid kit of claim 1, wherein the benzyl alcohol is present in the solubilizing agent in an amount from about 10 wt % to about 40 wt %.

5. The multi-fluid kit of claim 1, wherein the water is present in the solubilizing agent in an amount from about 20 wt % to about 70 wt %.

6. A three-dimensional printing kit comprising:
a powder bed material comprising polyamide polymer particles; and
a solubilizing agent comprising from about 10 wt % to about 40 wt % benzyl alcohol, an organic cosolvent, and water.

7. The three-dimensional printing kit of claim 6, wherein the solubilizing agent further comprises an electromagnetic radiation absorber, wherein the electromagnetic radiation absorber absorbs radiation energy and converts the radiation energy to heat.

8. The three-dimensional printing kit of claim 6, further comprising a fusing agent comprising water and an electromagnetic radiation absorber, wherein the electromagnetic radiation absorber absorbs radiation energy and converts the radiation energy to heat.

9. The three-dimensional printing kit of claim 6, wherein the polyamide polymer particles comprise polyamide 6, polyamide 9, polyamide 11, polyamide 12, polyamide 66, polyamide 612, thermoplastic polyamide, polyamide copolymer, or a combination thereof.

10. The three-dimensional printing kit of claim 6, wherein the organic cosolvent is polyethylene glycol having a molecular weight of about 200 Mw or greater.

11. The three-dimensional printing kit of claim 6, wherein the organic cosolvent is present in the solubilizing agent in an amount from about 20 wt % to about 70 wt %, wherein the benzyl alcohol is present in the solubilizing agent in an amount from about 10 wt % to about 20 wt %, and wherein the water is present in the solubilizing agent in an amount from about 20 wt % to about 70 wt %.

12. A three-dimensional printed object prepared using the three-dimensional printing kit of claim 6, the three-dimensional printed object comprising multiple fused layers of the powder bed material having the benzyl alcohol and an electromagnetic radiation absorber embedded in the fused layers of powder bed material, wherein the electromagnetic radiation absorber absorbs radiation energy and converts the radiation energy to heat.

13. A system for three-dimensional printing comprising:
a powder bed material comprising polyamide polymer particles;
a fusing agent to selectively apply to a layer of the powder bed material, wherein the fusing agent comprises water and an electromagnetic radiation absorber, wherein the electromagnetic radiation absorber absorbs radiation energy and converts the radiation energy to heat;
a solubilizing agent to selectively apply to the layer of the powder bed material, wherein the solubilizing agent comprises from about 10 wt % to about 40 wt % benzyl alcohol, an organic cosolvent, and water; and
a radiant energy source positioned to expose the layer of powder bed material to radiation energy to selectively fuse the polyamide polymer particles in contact with the electromagnetic radiation absorber and thereby form a three-dimensional printed object.

14. The system of claim 13, wherein the polyamide polymer particles comprise polyamide 6, polyamide 9, polyamide 11, polyamide 12, polyamide 66, polyamide 612, thermoplastic polyamide, polyamide copolymer, or a combination thereof.

15. The system of claim 13, wherein the organic cosolvent includes polyethylene glycol.
